(19) United States
(12) Patent Application Publication
(10) Pub. No.: US 2013/0019447 A1
(43) Pub. Date: Jan. 24, 2013

(54) TUBE CONNECTOR WITH SLIP RINGS

(71) Applicants: John S. Fitch, Los Altos, CA (US); David K. Fork, Mountain View, CA (US); Philip L. Gleckman, Sunnyvale, CA (US)

(72) Inventors: John S. Fitch, Los Altos, CA (US); David K. Fork, Mountain View, CA (US); Philip L. Gleckman, Sunnyvale, CA (US)

(73) Assignee: Google Inc., Mountain View, CA (US)

(21) Appl. No.: 13/187,873

(22) Filed: Jul. 21, 2011

(51) Int. Cl. F16L 41/02; B23P 11/00

(52) U.S. Cl. 29/428; 285/133.21

(57) ABSTRACT

The subject matter of this specification can be embodied in, among other things, a method that includes a T-shaped tubular connection that includes a first member with a first fluid passageway disposed in a first direction, a shoulder boss disposed on the first member, and a tubular member disposed on the boss. A second fluid passageway is disposed through the tubular member and through the boss in a second direction perpendicular to the first direction, and is fluidly connected to the first fluid passageway of the first member. The connection also includes a second member having a third passageway with a cylindrical bore located at a proximal end of the third passageway, the cylindrical bore being adapted to be received on the outer cylindrical surface of the first tubular member, and at least two ring seals adapted to be received in the at least two ring seal grooves.

### TECHNICAL FIELD

This instant specification relates to fluid conduit connectors.

### BACKGROUND

Fluid conduits and connectors have been used for centuries in various applications such as freshwater and wastewater plumbing systems. Standardization of the sizes of fluid conduits and connectors has allowed plumbers, steamfitters, and other such workers to assemble fluid conduit systems by using prefabricated materials.

Some fluid conduit systems are constructed to convey heated or cooled fluids. As these fluids flow through fluid conduits and connectors, the materials used to construct such conduits and connectors can exhibit thermal expansion and contraction. Such thermal characteristics can cause changes in a conduit or connector's length, diameter, or both. Such thermal characteristics can be problematic to the creation of structurally sound (e.g., airtight, watertight) connections, and can be particularly problematic when two or more components with differing thermal characteristics are joined.

### SUMMARY

In general, this document describes fluid conduit connectors.

In a first aspect, a T-shaped tubular connection includes a first member that includes a first internal fluid passageway disposed in a first direction, a shoulder boss disposed on the first member, and a tubular member disposed on the boss, said tubular member having a cylindrical outer surface and at least two ring seal grooves disposed circumferentially on the outer cylindrical surface of the first tubular member. A second internal fluid passageway is disposed through the tubular member and through the boss in a second direction perpendicular to the first direction, said second internal fluid passageway fluidly connected to the first internal fluid passageway of the first member. The connection also includes a second member that includes a third passageway with a cylindrical bore located at a proximal end of the third internal passageway, the cylindrical bore being adapted to be received on the outer cylindrical surface of the first tubular member, and at least two ring seals adapted to be received in the at least two ring seal grooves.

Implementations can include any, all, or none of the following features. The cylindrical bore can have a predetermined internal diameter, said internal diameter of the bore being greater than an outer diameter of the first tubular member. The tubular connection can also include a fourth fluid passageway extending from an exterior surface of the second member to the cylindrical bore, said fourth passageway having a distal end terminating between the at least two ring grooves. The fourth fluid passage can be adapted for injection of a seal fluid at a higher pressure than a fluid flowing through the third passageway. The fluid flowing through the first and third passageways can be a working fluid in a solar power plant and the seal fluid injected through the fourth passageway is a lower temperature fluid. The second member can be formed from ceramic.

In a second aspect, a T-shaped tubular connection includes a first member including a first internal fluid passageway disposed in a first direction, a shoulder boss disposed on the first member, and a tubular member disposed on the boss, said tubular member having a second internal fluid passageway through the tubular member and through the boss and disposed in a second direction generally perpendicular to the first direction, said second internal fluid passageway fluidly connected to the first internal fluid passageway of the first member, an inner cylindrical bore located at a proximal end of the second internal fluid passageway, and at least two ring seal grooves disposed circumferentially in the inner cylindrical bore of the first tubular member. A second member includes an outer surface with a proximal portion having a cylindrical outer surface being adapted to be received in the cylindrical bore of the tubular member, and a third internal passageway disposed through the second member. At least two ring seals are adapted to be received in the at least two ring seal grooves.

Implementations can include all, some, or none of the following features. An outer diameter of the proximal end of the second member can be less than the internal diameter of the tubular member. The tubular connection can also include a fourth fluid passageway extending from an outer surface of the tubular member to the cylindrical bore, said fourth passageway having a distal end terminating between the at least two ring seal grooves. The fourth fluid passageway can be adapted for injection of a seal fluid at a higher pressure than a fluid flowing through the third passageway. The fluid flowing through the first and third passageways can be a working fluid in a solar power plant and the seal fluid injected through the fourth passageway can be a lower temperature fluid. The second member can be formed from ceramic.

In a third aspect a method for assembly of a tubular connection includes providing a first member including a first internal fluid passageway, a shoulder boss disposed on the first member, and a tubular member disposed on the boss. The tubular member has a cylindrical outer surface and at least two ring seal grooves disposed circumferentially on the outer cylindrical surface of the first tubular member, and a second internal fluid passageway disposed through the tubular member and through the boss, said second internal fluid passageway fluidly connected to the first internal fluid passageway of the first member. At least one ring seal is positioned in each of the ring seal grooves, and a cylindrical bore is inserted at a proximal end of a second member onto the outer cylindrical surface of the first tubular member.

In a fourth aspect, a method for assembly of a tubular connection includes providing a first member having a first internal fluid passageway, a shoulder boss disposed on the first member, and a tubular member disposed on the boss, said tubular member having a second internal fluid passageway through the tubular member and through the boss and disposed in a second direction generally perpendicular to the first direction, said second internal fluid passageway fluidly connected to the first internal fluid passageway of the first member, an inner cylindrical bore located at a proximal end of the second internal fluid passageway, and at least two ring seal grooves disposed circumferentially in the inner cylindrical bore of the first tubular member. The method also includes positioning at least one ring seal in each of the ring seal grooves, and inserting a cylindrical outer surface of a second member in the cylindrical bore of the tubular member.

In a fifth aspect, a method for use of a tubular connection includes providing a first member including a first internal fluid passageway, a shoulder boss disposed on the first member, a tubular member disposed on the boss, said tubular member having a cylindrical outer surface and at least two ring seal grooves disposed circumferentially on the outer cylindrical surface of the first tubular member and a second internal fluid passageway disposed through the tubular member and through the boss, said second internal fluid passageway fluidly connected to the first internal fluid passageway of the first member. The method also includes positioning at least one ring seal in each ring seal groove, inserting a cylindrical bore at a proximal end of a second member on the outer cylindrical surface of the first tubular member, said second cylindrical bore of the member being fluidly connected to a third internal passageway disposed in the second member flowing a working fluid through the first, second and third passageways of the tubular connection, and injecting a seal fluid into a fourth fluid passageway extending from an exterior surface of the second member to the cylindrical bore, said fourth passageway having a distal end terminating between the first and second ring grooves, wherein the seal fluid is injected at a higher pressure than the working fluid flowing through the third passageway.

Implementations can include all, some, or none of the following features. Flowing a working fluid through the first, second and third passageways further comprises flowing a high energy working fluid from a receiver in a solar power plant, and injecting a seal fluid further comprises injecting a seal fluid injected through the fourth passageway at a lower temperature than the working fluid.

In a sixth aspect, a method for use of a tubular connection includes providing a first member having a first internal fluid passageway, a shoulder boss disposed on the first member, a tubular member disposed on the boss, said tubular member having a second internal fluid passageway through the tubular member and through the boss and disposed in a second direction generally perpendicular to the first direction, said second internal fluid passageway fluidly connected to the first internal fluid passageway of the first member, a cylindrical bore located at a proximal end of the second internal fluid passageway, and at least two ring seal grooves disposed circumferentially in the inner cylindrical bore of the first tubular member. The method also includes positioning at least one ring seal in each of the ring seal grooves, inserting a cylindrical outer surface of a second member in the cylindrical bore of the tubular member, said second member having a third internal passageway disposed in the second member, flowing a working fluid through the first, second and third passageways of the tubular connection, and injecting a seal fluid into a fourth fluid passageway extending from an exterior surface of the second member to the cylindrical bore, said fourth passageway having a distal end terminating between the first and second ring grooves wherein the seal fluid is injected at a higher pressure than the working fluid flowing through the third passageway.

Implementations can include any, all, or none of the following features. Flowing a working fluid through the first, second and third passageways can also include flowing a high energy working fluid from a receiver in a solar power plant, injecting a seal fluid can also include injecting a seal fluid through the fourth passageway at a lower temperature than the working fluid.

The systems and techniques described here may provide one or more of the following advantages. First, a system can provide a fluid coupling that is compliant to changes in the diameters of various ones of its constituent components. The system can provide a fluid coupling that is compliant to changes in the diameters of various ones of its constituent components. The system can provide a fluid coupling that is compliant to changes in the lengths and penetrating depths of various ones of its constituent components. The system can provide a fluid coupling that uses a counter-pressurizing sealing fluid to substantially reduce leakage of a working fluid across a seal. The system can provide a fluid coupling that uses a counter-pressurizing sealing fluid to substantially reduce leakage, across a seal, of a value-added property of a working fluid. The system can provide a fluid coupling that reduces leakage of a working fluid in a solar energy facility. The system can provide a fluid coupling that can maintain a substantially sealed connection between two fluid components having different coefficients of thermal expansion across a predetermined range of temperatures and working fluid pressures.

The details of one or more implementations are set forth in the accompanying drawings and the description below. Other features and advantages will be apparent from the description and drawings, and from the claims.

### DESCRIPTION OF DRAWINGS

FIGS. 1 and 1A are cutaway views of an example tubular connection system.

FIGS. 2 and 2A are cutaway views of another example tubular connection system.

FIG. 3 is a flow chart that shows an example of a process for assembly of a tubular connection.

### DETAILED DESCRIPTION

This document describes systems and techniques for forming and assembling fluid connections. In some implementations, the fluids can include liquids, gases, plasmas, plastic solids, and/or combinations of these and other substances that deform under applied shear stress. In general, fluid circuits are formed by assembling prefabricated conduits and connectors. In many applications (e.g., household plumbing), the joints between two conduits and/or connectors are typically joined through the use of solder, adhesive cement, or press-fit seals. In other applications, however, such joining techniques may not be practical or effective. For example, in some applications, the fluid being passed through the fluid circuit may heat or cool the conduits and connectors of the circuit. Such heating and cooling can cause the materials that make up the connectors and conduits to expand and/or contract, causing the diameters and/or lengths of the components to increase and decrease, thereby possibly causing stresses and leaks at joints in the circuit.

Such issues can increase when two components with different thermal expansion characteristics are joined (e.g., metal to plastic, metal to ceramic), since the two components may expand and contract by different amounts. For example, a ceramic male component may be fitted into a female metallic component, and when heated the female components may expand more than the ceramic and may create a gap between the components through which a fluid may leak. In another example, a first conduit may be connected to a second conduit through a solidly connected tee connector. As the first conduit elongates and shortens with changes in temperature, unwanted lateral forces may be applied to the second conduit.

In general, such thermal changes can be accommodated through the use of compliant fluid connectors; for example, connectors that implement compliant seals (e.g., O-rings) between the components. As such, the compliant seals can fill gaps that may be formed as male and female components expand and contract in diameter, and can allow the components to slip axially or rotationally while remaining sealed.

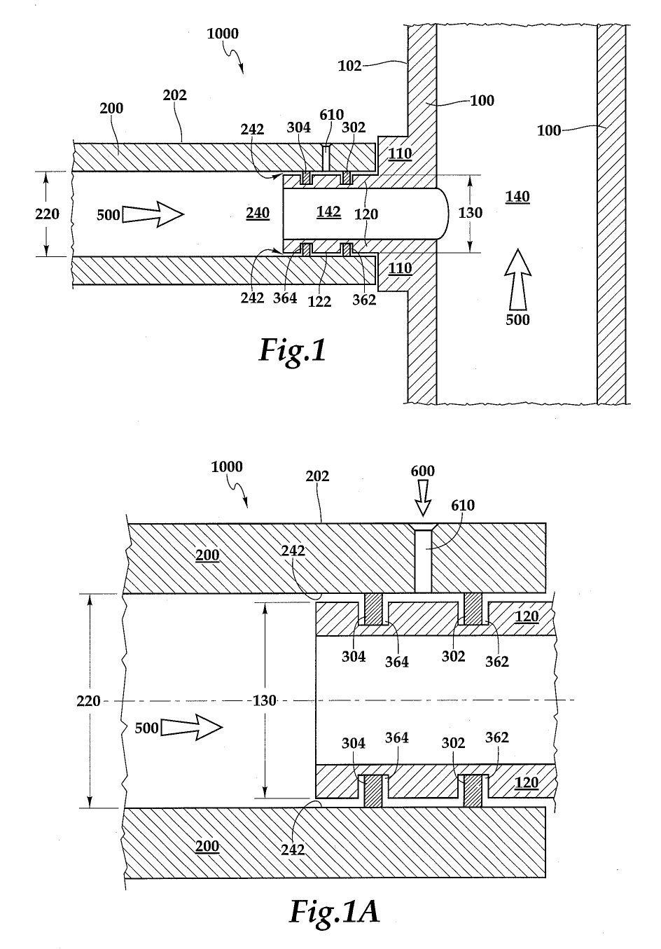

FIGS. 1 and 1A are cutaway views of an example tubular connection system 1000. The system 1000 includes a fluid member 100. The fluid member 100 includes an internal fluid passageway 140 and a shoulder boss 110. A tubular member 120 is disposed on the shoulder boss 110.

The tubular member 120 includes a cylindrical outer surface 122, a ring seal groove 362, and a ring seal groove 364. The ring seal grooves 362, 364 are disposed circumferentially about the outer cylindrical surface of the tubular member 120. A ring seal 302 is positioned in the ring seal groove 362, and a ring seal 304 is positioned in the ring seal groove 364. A fluid passageway 142 is formed through the tubular member 120 and the shoulder boss 110, and is fluidly connected to the fluid passageway 140. In some implementations, two, three, four, or more ring seals and respective ring seal grooves may be provided to substantially prevent leakage of the fluid 500.

The system 1000 also includes a fluid member 200 having a cylindrical outer surface 202 and a cylindrical bore 242, and a fluid passageway 240. The cylindrical bore 242 is adapted to be received about the cylindrical outer surface 122 of the tubular member 120. The cylindrical bore 242 has an internal diameter 220 that is greater than an outer diameter 130 of the tubular member 120. As such, the fluid member 200 may slip over the tubular member 120 and the ring seals 302, 304.

In some implementations, the ring seals 302, 304 can be selected to substantially seal the gap between the outer diameter 130 and the internal diameter 220. For example, the radial thicknesses, the elastomeric compliance, and/or a combination of these and other qualities may be used in the selection of the ring seals 302, 304.

The tubular member 200 also includes a fluid passageway 610. The fluid passageway 610 extends from a proximal end at the exterior surface 202 of the fluid member 200 to a distal end at the cylindrical bore 242. The distal end of the fluid passageway 610 terminates between the ring seal grooves 362, 364.

The fluid passageway 610 is adapted for injection of a seal fluid 600. The seal fluid 600 is injected at a pressure substantially equal to or greater than the pressure of a fluid 500 flowing through the fluid passageway 240. In some implementations, by providing the seal fluid 600 under pressure, the differential pressure across the ring seal 304 may be substantially equalized or balanced. For example, by counter-pressurizing the ring seal 304, leakage of the fluid 500 may be substantially reduced or eliminated.

In some implementations, the system 1000 may be used to preserve the content or qualities of the fluid 500. For example, the fluid 500 may be a rare or expensive fluid (e.g., purified gases, propane, coolant) while the seal fluid 600 may be a common or inexpensive fluid (e.g., water, air). As such, any leakage across the ring seal 302 may be considered a sacrificial loss, and a less costly one than a loss of the fluid 500.

In another example, the fluid 500 may be processed to add a valuable characteristic to it, such as by heating, cooling, oxygenating, purifying, drying, or by any other appropriate process that can add value to a fluid. As such, the seal fluid 600 may be fluid that has not had a value-adding process applied to it. For example, the fluid 500 can be heated air, while the seal fluid 600 can be ambient air. As such, the non-value added seal fluid 600 can substantially balance the differential pressure across the ring seal 304 and substantially reduce or prevent the loss of the value quality added to the fluid 500 (e.g., heat in this example). In some implementations, the system 1000 can be used in a solar power plant. For example, the fluid 500 can be air or any other appropriate working fluid that is heated by solar power, and the seal fluid 600 can be a fluid injected through the passageway 610 at a lower temperature (e.g., unheated).

In some implementations, the fluid member 100, the tubular member 120, and/or the fluid member 200 can be made of ceramic, metal, plastic, glass, or any other appropriate material. In some implementations, the tubular member 120 and the fluid member 200 may be made of different materials. For example, the tubular member 120 may be made of metal, and the fluid member 200 may be made of ceramic. Since metals generally have a higher thermal coefficient of expansion than do ceramics, it may be anticipated that the tubular member 120 may expand more so than the fluid member 200 when heated by the fluid 500. The outer diameter 130 and the cylindrical bore 242 may be selected such that the outer diameter 130 will not equal or exceed the cylindrical bore 242 under anticipated thermal conditions (e.g., so the tubular member 120 will not expand far enough to burst the ceramic of the fluid member 200), and the ring seals 302, 304 may be selected to substantially seal the gap across the anticipated pressures and thermal conditions.

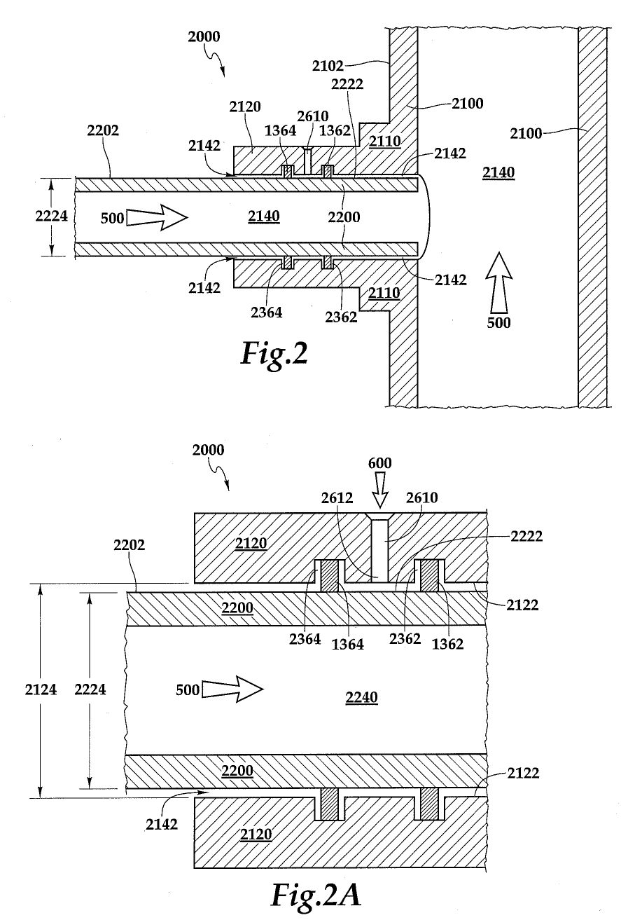

FIGS. 2 and 2A are cutaway views of another example tubular connection system 2000. In general, the system 2000 resembles the system 1000 with the genders of the tubular member 120 and the fluid member 200 reversed.

The system 2000 includes a fluid member 2100. The fluid member 2100 includes an internal fluid passageway 2140 and a shoulder boss 2110 disposed on the fluid member 2100. A tubular member 2120 is disposed on the shoulder boss 2110, and includes a fluid passageway 2142. The fluid passageway 2142 passes through the tubular member 2120 and the shoulder boss 2110, and fluidly connects to the fluid passageway 2140. The tubular member 2120 is oriented in a direction that is substantially perpendicular to the general direction of flow through the fluid passageway 2140.

The tubular member 2120 has an inner cylindrical bore 2122 located at a proximal end of the fluid passageway 2142, and a ring seal groove 2362 and a ring seal groove 2364 disposed circumferentially within the inner cylindrical bore 2122 of the tubular member 2120.

A fluid passageway 2610 extends from an outer surface 2102 of the tubular member 2120 to the inner cylindrical bore 2122. The fluid passageway 2610 extends through the tubular member 2120 to a distal end 2612 terminating between the ring seal grooves 2362, 2364.

A fluid member 2200 includes an outer surface 2202 with a proximal portion having a cylindrical outer surface 2222. The cylindrical outer surface 2222 is dimensioned so as to be received in the inner cylindrical bore 2122 of the tubular member 2120. An outer diameter 2224 of the proximal end of the fluid member 2200 is less than the internal diameter 2124 of the tubular member 2120. The fluid member 2200 includes a fluid passageway 2240 disposed through the fluid member 2200.

A ring seal 1362 and a ring seal 1364 are located in the ring seal grooves 2362 and 2364. In some implementations, the width, thickness, and materials of the ring seals 1362, 1364 can be selected so as to substantially prevent leakage of the fluid 500 through the gap between the inner cylindrical bore 2122 and the fluid member 2200. In some implementations, two, three, four, or more ring seals and respective ring seal grooves may be provided to substantially prevent leakage of the fluid 500.

The fluid passageway 2610 is adapted for injection of the seal fluid 600. The seal fluid 600 is injected at a pressure substantially equal to or greater than the pressure of a fluid 500 flowing through the fluid passageway 2140. In some implementations, by providing the seal fluid 600 under pressure, the differential pressure across the ring seal 1362 may be substantially equalized or balanced against the pressure provided by the fluid 500. For example, by counter-pressurizing the ring seal 1362, leakage of the fluid 500 may be substantially reduced or eliminated.

As similarly discussed in the description of the system 1000, in some implementations, the system 2000 may also be used to preserve the content or qualities of the fluid 500. For example, the fluid 500 may be a rare or expensive fluid (e.g., purified gases, propane, coolant) while the seal fluid 600 may be a common or inexpensive fluid (e.g., water, air). As such, leakage across the ring seal 1364 may be considered a sacrificial loss, and a less costly one than a loss of the fluid 500. Likewise, the system 2000 may be implemented to prevent loss of value that has been added to the fluid 500, such as thermal energy, drying, purification, or any other appropriate process that can add a valued property to the fluid 500.

In some implementations, the system 2000 can be used in a solar power plant. For example, the fluid 500 can be air, water, steam, glycol, liquid sodium, or any other appropriate working fluid that is heated by solar power, and the seal fluid 600 can be a similar or different fluid injected through the passageway 2610 at a lower temperature (e.g., unheated). In some implementations, the fluid member 2200 can be formed from a ceramic material.

In some implementations, the use of the ring seals 302, 304, 1362, and 1364 can provide structural compliance to the systems 1000 and 2000 as the various components shift, or expand and contract with changes in temperature. For example, the fluid members 200 and 2202 may be of considerable length, and as such may experience proportionally considerable changes in length as the fluid members 200 and 2202 are heated and cooled. These changes in position and/or length can cause the fluid members 200 and 2202 to exhibit a varying degree of penetration of/by their respective tubular members 120 and 2120. As the fluid members 200 and 2202 shift relative to their respective tubular members 120 and 2120, the ring seals 302, 304, 1362, and 1364 can maintain a seal. The positions of the fluid passageways 610 and 2610 can remain positioned relatively between their respective ring seal grooves 362, 364, 2362, and 2364, so as to provide the sealing fluid and maintain a counter-pressurization against the fluid 500 as the fluid members 200 and 2202 shift.

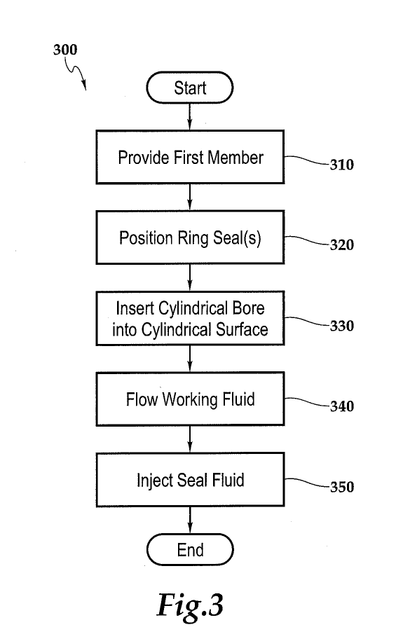

FIG. 3 is a flow chart that shows an example of a process 300 for assembly and use of a tubular connection, such as the connections depicted by the system 1000 of FIGS. 1-1A. The process 300 begins at step 310 where a first member is provided. The first member includes a first internal fluid passageway, a shoulder boss disposed on the first member, and a tubular member disposed on the boss. For example, the fluid member 100 includes the fluid passageway 140, the shoulder boss 110, and the tubular member 120. The tubular member includes a cylindrical outer surface and at least two ring seal grooves disposed circumferentially on the outer cylindrical surface of the first tubular member, and a second internal fluid passageway disposed through the tubular member and through the boss, said second internal fluid passageway fluidly connected to the first internal fluid passageway of the first member. For example, the tubular member 120 includes the cylindrical outer surface 122, the ring seal grooves 362, 364, and the fluid passageway 142 connected to the fluid passageway 140.

At step 320, at least one ring seal is positioned in each ring seal groove. For example, the ring seals 302 and 304 are positioned in the ring seal grooves 362 and 364, respectively.

At step 330, a cylindrical bore is inserted at a proximal end of a second member on the outer cylindrical surface of the first tubular member. The second cylindrical bore of the member is fluidly connected to a third internal passageway disposed in the second member. For example, the proximal end of the fluid member 200 is inserted on the outer cylindrical surface 122 of the tubular member 120 and fluidly connects the fluid passageway 140 to the fluid passageway 240 of the fluid member 200.

At step 340, a working fluid is flowed through the first, second, and third passageways of the tubular connection. For example, the fluid 500 can be made to flow through the fluid passageways 140, 142, and 240 of the system 1000.

At step 350, a seal fluid is injected into a fourth fluid passageway extending from an exterior surface of the second member to the cylindrical bore. The fourth passageway has a distal end terminating between the first and second ring grooves. The seal fluid is injected at a higher pressure than the working fluid flowing through the third passageway. For example, the seal fluid 600 can be injected into the fluid passageway 610 and into the cavity between the ring seals 302, 304.

In some implementations, the working fluid in step 340 can be a high energy working fluid from a receiver in a solar power plant, and the seal fluid injected through the fourth passageway in step 350 can be injected at a lower temperature than the working fluid. For example, solar heated air can flow through the system 1000 as the fluid 500, and ambient air can be used as the seal fluid 600. In some implementations, such a configuration can help prevent the leakage of heat across the ring seals 302, 304.

While the process 300 has been described in terms of a system such as the system 1000, it should be noted that the process 300, with minor modifications, can apply equally well to the system 2000 of FIGS. 2-2A. For example, step 310 can be modified to describe the tubular member 2120, step 320 can be modified to describe positioning the ring seals 1362 and 1364 in the ring seal grooves 2362 and 2364, and step 330 can be modified to describe the insertion of the fluid member 2202 into the tubular member 2120.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A T-shaped tubular connection comprising:
a first member including:
a first internal fluid passageway disposed in a first direction,
a shoulder boss disposed on the first member, and
a tubular member disposed on the boss, said tubular member having:
a cylindrical outer surface and at least two ring seal grooves disposed circumferentially on the outer cylindrical surface of the first tubular member, and
a second internal fluid passageway disposed through the tubular member and through the boss in a second direction perpendicular to the first direction, said second internal fluid passageway fluidly connected to the first internal fluid passageway of the first member;
a second member having:
a third passageway with a cylindrical bore located at a proximal end of the third internal passageway, the cylindrical bore being adapted to be received on the outer cylindrical surface of the first tubular member; and
at least two ring seals adapted to be received in the at least two ring seal grooves.

2. The tubular connection of claim 1 wherein the cylindrical bore has a predetermined internal diameter, said internal diameter of the bore being greater than an outer diameter of the first tubular member.

3. The tubular connection of claim 1 further including a fourth fluid passageway extending from an exterior surface of the second member to the cylindrical bore, said fourth passageway having a distal end terminating between the at least two ring grooves.

4. The tubular connection of claim 3 wherein the fourth fluid passage is adapted for injection of a seal fluid at a higher pressure than a fluid flowing through the third passageway.

5. The tubular connection of claim 3 wherein the fluid flowing through the first and third passageways is a working fluid in a solar power plant and the seal fluid injected through the fourth passageway is a lower temperature fluid.

6. The tubular connection of claim 1 wherein the second member is formed from ceramic.

7. A T-shaped tubular connection comprising:
a first member including:
a first internal fluid passageway disposed in a first direction,
a shoulder boss disposed on the first member, and
a tubular member disposed on the boss, said tubular member having:
a second internal fluid passageway through the tubular member and through the boss and disposed in a second direction generally perpendicular to the first direction, said second internal fluid passageway fluidly connected to the first internal fluid passageway of the first member,
an inner cylindrical bore located at a proximal end of the second internal fluid passageway, and
at least two ring seal grooves disposed circumferentially in the inner cylindrical bore of the first tubular member;
a second member having:
an outer surface with a proximal portion having a cylindrical outer surface being adapted to be received in the cylindrical bore of the tubular member, and
a third internal passageway disposed through the second member; and
at least two ring seals adapted to be received in the at least two ring seal grooves.

8. The tubular connection of claim 7 wherein an outer diameter of the proximal end of the second member is less than the internal diameter of the tubular member.

9. The tubular connection of claim 7 further including a fourth fluid passageway extending from an outer surface of the tubular member to the cylindrical bore, said fourth passageway having a distal end terminating between the at least two ring seal grooves.

10. The tubular connection of claim 9 wherein the fourth fluid passageway is adapted for injection of a seal fluid at a higher pressure than a fluid flowing through the third passageway.

11. The tubular connection of claim 9 wherein the fluid flowing through the first and third passageways is a working fluid in a solar power plant and the seal fluid injected through the fourth passageway is a lower temperature fluid.

12. The tubular connection of claim 7 wherein the second member is formed from ceramic.

13. A method for assembly of a tubular connection comprising:
providing a first member including:
a first internal fluid passageway,
a shoulder boss disposed on the first member, and
a tubular member disposed on the boss, said tubular member having:
a cylindrical outer surface and at least two ring seal grooves disposed circumferentially on the outer cylindrical surface of the first tubular member, and
a second internal fluid passageway disposed through the tubular member and through the boss, said second internal fluid passageway fluidly connected to the first internal fluid passageway of the first member;
positioning at least one ring seal in each of the ring seal grooves; and
inserting a cylindrical bore at a proximal end of a second member onto the outer cylindrical surface of the first tubular member.

14. A method for assembly of a tubular connection comprising:
providing a first member having:
a first internal fluid passageway,
a shoulder boss disposed on the first member, and
a tubular member disposed on the boss, said tubular member having:
a second internal fluid passageway through the tubular member and through the boss and disposed in a second direction generally perpendicular to the first direction, said second internal fluid passageway fluidly connected to the first internal fluid passageway of the first member,
an inner cylindrical bore located at a proximal end of the second internal fluid passageway, and
at least two ring seal grooves disposed circumferentially in the inner cylindrical bore of the first tubular member;
positioning at least one ring seal in each of the ring seal grooves; and
inserting a cylindrical outer surface of a second member in the cylindrical bore of the tubular member.

15. A method for use of a tubular connection comprising:
providing a first member including:
a first internal fluid passageway,
a shoulder boss disposed on the first member,
a tubular member disposed on the boss, said tubular member having:
a cylindrical outer surface and at least two ring seal grooves disposed circumferentially on the outer cylindrical surface of the first tubular member, and
a second internal fluid passageway disposed through the tubular member and through the boss, said second internal fluid passageway fluidly connected to the first internal fluid passageway of the first member;
positioning at least one ring seal in each ring seal groove;
inserting a cylindrical bore at a proximal end of a second member on the outer cylindrical surface of the first tubular member, said second cylindrical bore of the member being fluidly connected to a third internal passageway disposed in the second member flowing a working fluid through the first, second and third passageways of the tubular connection,
injecting a seal fluid into a fourth fluid passageway extending from an exterior surface of the second member to the cylindrical bore, said fourth passageway having a distal end terminating between the first and second ring grooves, wherein the seal fluid is injected at a higher pressure than the working fluid flowing through the third passageway.

16. The method of claim 15 wherein flowing a working fluid through the first, second and third passageways further comprises flowing a high energy working fluid from a receiver in a solar power plant, and injecting a seal fluid further comprises injecting a seal fluid injected through the fourth passageway at a lower temperature than the working fluid.

17. A method for use of a tubular connection comprising:
providing a first member having:
a first internal fluid passageway,
a shoulder boss disposed on the first member;
a tubular member disposed on the boss, said tubular member having:
a second internal fluid passageway through the tubular member and through the boss and disposed in a second direction generally perpendicular to the first direction, said second internal fluid passageway fluidly connected to the first internal fluid passageway of the first member,
a cylindrical bore located at a proximal end of the second internal fluid passageway, and
at least two ring seal grooves disposed circumferentially in the inner cylindrical bore of the first tubular member;
positioning at least one ring seal in each of the ring seal grooves;
inserting a cylindrical outer surface of a second member in the cylindrical bore of the tubular member, said second member having a third internal passageway disposed in the second member;
flowing a working fluid through the first, second and third passageways of the tubular connection; and
injecting a seal fluid into a fourth fluid passageway extending from an exterior surface of the second member to the cylindrical bore, said fourth passageway having a distal end terminating between the first and second ring grooves wherein the seal fluid is injected at a higher pressure than the working fluid flowing through the third passageway.

18. The method of claim 17 wherein flowing a working fluid through the first, second and third passageways further comprises flowing a high energy working fluid from a receiver in a solar power plant, injecting a seal fluid further comprises injecting a seal fluid through the fourth passageway at a lower temperature than the working fluid.
